(19) United States
(12) Patent Application Publication
(10) Pub. No.: US 2015/0183642 A1
(43) Pub. Date: Jul. 2, 2015

(54) Systems and Methods for Nanoscopically Aligned Carbon Nanotubes

(71) Applicant: Nanocomp Technologies, Inc., Merrimack, NH (US)

(72) Inventors: David S. Lashmore, Lebanon, NH (US); Mark Schauer, Dublin, NH (US); Diana Lewis, Concord, NH (US); Thomas Van Vechten, Warner, NH (US); David Degtiarov, Concord, NH (US)

(21) Appl. No.: 14/556,793

(22) Filed: Dec. 1, 2014

Related U.S. Application Data
(63) Continuation of application No. 14/235,648, now abandoned.
(60) Provisional application No. 61/512,873, filed on Jul. 28, 2011.

(51) Int. Cl. C01B 31/02; B01J 4/00; B29B 13/00; B01J 19/24

(52) U.S. Cl. CPC C01B 31/0266; B01J 19/24; B01J 4/007; C01B 31/0246; B29B 13/00; B01J 2219/24; B29L 2023/00

(57) ABSTRACT

The present invention relates to systems and methods for generating nanoscopically aligned carbon nanotubes in yarns, tapes and sheets. Some embodiments relate to methods and systems to allow in situ alignment of the tubes within the growth chamber. In particular, processes for in situ alignment include: (1) gas flow alignment using gas lenses introduced within the reaction tube, (2) electrostatic alignment using electrostatic lenses surrounding the reaction tube, (3) gas flow alignment by convergent flow within the reaction tube, (4) placing catalysts on a fixed substrate and flowing reaction gas parallel to the substrate. Other embodiments involve post processing of the CNT material in order to align the materials once it has been produced. In particular, processes for ex situ alignment include: (1) introducing a horizontal anchor within a standard sheet system and stretching that sheet with respect to a fixed drum and (2) adding chemicals to a sheet, tape or yarn to help break electrostatic bonds and enable stretch alignment.

### RELATED APPLICATIONS

This application claims priority to U.S. Provisional Application Ser. No. 61/512,873, filed Jul. 28, 2011, the disclosure of which is hereby incorporated herein by reference in its entirety.

### GOVERNMENT SUPPORT

The invention is supported, in whole or in part, by the U.S. Government under contract Number: 000-11-C-0324. The Government may have certain rights in the invention.

### TECHNICAL FIELD

The present invention relates to systems and methods for generating nanoscopically aligned carbon nanotubes.

### BACKGROUND ART

The production of long, substantially defect-free carbon nanotubes (CNTs) is useful in the making of macrostructures, such as yarns, tapes and sheets that can attain, to a significant degree, those properties of individual nanotubes necessary for use building blocks for these macrostructures. In general, nanotube growth by chemical vapor deposition growth process can be limited by various growth conditions, including; (1) fuel starvation, (2) catalyst size distribution, chemistry and stability, (3) catalyst surface energy, (4) nature of the reaction gas, (5) duration within the reaction zone, and (6) temperatures within of the reaction zone.

Due to the random nature of the growth and fabrication process, as well as the collection process, the texture, along with the position of the nanotubes within the nanofibrous extensible macrostructure may also be random. In other words, the nanotubes within these yarns, tapes or sheets may not be well aligned, particularly for the non-woven sheets.

Since there are certain physical and mechanical properties that are dependent on alignment, the random nature of the nanotubes within these extensible structures can affect the properties of these extensible structures. Macro-properties such as strength, electrical and thermal conductivity, the thermoelectric Seebeck coefficient and others are not only related to the properties of the individual tubes or bundles, but also critically to their alignment on the nanoscale. Other properties which may be affected include complex index of refraction, frequency dependency of resistivity, and chemical reactivity.

Accordingly, it would be desirable to provide a system and method capable of controlling the alignment of carbon nanotubes on the same order of dimension as the tubes themselves.

### SUMMARY OF THE INVENTION

The present invention provides, in some embodiments, various apparatus and processes for use with a system, such as a chemical vapor deposition (CVD) reactor, in the production of nanostructures, for example, nanotubes that can accomplish nano-alignment.

The present invention also provided methods and apparatus that can improve the growth process of carbon nanotubes sufficient to generate substantially pure and high quality single wall carbon nanotubes (SWNT) having diameters ranging from about 1 nm to about 50 nm.

Aspects of the invention relate to systems, methods and devices for aligning nanotubes. In some embodiments, the method comprises producing a volume of free-flowing carbon nanotubes in a synthesis chamber, constraining the free-flowing carbon nanotubes in a substantially axial direction so as to align the carbon nanotubes, allowing the carbon nanotubes to form an aggregate of substantially aligned carbon nanotubes, and collecting the aggregate of carbon nanotubes. In some embodiments, the method further comprises subjecting the aggregate to alignment, for example, by stretching after the material is made.

The present invention provides, in one embodiment, provides a system for producing aligned nanotubes, provided in connection with yarn or sheet. The system includes a synthesis chamber having a pathway into which a mixture can be introduced to generate nanotubes. The mixture can comprises catalyst particles, a carbon source and a gas carrier. The system also include a hot zone within the chamber and along which a volume of nanotubes can be generated from the mixture and an alignment region along the synthesis chamber downstream of the hot zone through which the volume of nanotubes can be condensed and the nanotubes deflected into substantial alignment relative to one another. The volume of nanotubes, in various embodiments, can be free-flowing

In one embodiment, the alignment region can be a tapered section of the synthesis chamber with a relatively smaller diameter pathway therethrough to condense and deflect the nanotubes into substantial alignment. The system, in one embodiment, can also have a conical section with a relatively constricted diameter relative to the tapered section to further condense and align the nanotubes. The alignment region, in one embodiment, may be a conical section of the synthesis chamber with a relatively smaller diameter pathway therethrough to condense and deflect the nanotubes into substantial alignment. The system, in one embodiment, can further have perforations positioned substantially circumferentially about the alignment region through which a flow of gas can be introduced in order to minimize adherence for the nanotubes to the alignment region.

The alignment region, in another embodiment, can include a disc having at least one orifice through which the volume of nanotubes can flow, the orifice having a diameter relatively smaller than that of the pathway to condense and deflect the nanotubes into substantial alignment. The disc may be at an angle to the flowing volume of nanotubes so as to minimize build up of the nanotubes at the orifice of the disc. In some embodiments, the alignment region can include a plurality of discs in linear alignment relatively to one another, each successive downstream disc having a successively smaller diameter orifice to further condense and align the nanotubes.

The alignment region, in another embodiment, can include an electrostatic lens that can generate an electrostatic field to condense and deflect the volume of nanotubes into substantial alignment moving therethrough. In some embodiments, the alignment region can include a plurality of electrostatic lenses in co-axial alignment with one another and having different voltages so as to successively condense and align the nanotubes moving therethrough. In some embodiments, the system can further have a particle charger upstream of the alignment region to charge the mixture from which nanotubes can be generated.

The present invention, in a further embodiment, provides a system with a pathway having a rotating looped belt onto which the mixture can be affixed. The belt can be rotated into the hot zone to permit growth of nanotubes from the affixed mixture on the belt. The hot zone, in one embodiment, can include an injector for introducing an additional carbon source to the mixture for nanotube growth. The system, in one embodiment, can include a scraping device downstream of the hot zone to remove residue of the mixture once the nanotubes have been collected.

The present invention, in a further embodiment, provides a system with a rotating anchor positioned adjacent an exit of the synthesis chamber and around which the nanotubes exiting the synthesis chamber can be directed for subsequent stretching and further alignment. The anchor, in various embodiments, can include a series of slots provided circumferentially about the anchor and onto which the nanotubes can be restrained while being pulled by a downstream force to further align the nanotubes.

The present invention, also provides a system for alignment of nanotubes collected from a furnace. The system includes a housing in fluid communication with the furnace, a first drum rotatable at a predetermined velocity, and being positioned within the housing adjacent an exit of the furnace to permit a collection nanotubes from the furnace to be deposited thereon, and a second rotatable drum being positioned downstream of the first anchor to receive nanotubes directed from the first anchor, the second drum being rotatable at a velocity different from that of the first drum in order to stretch and align the collection of nanotubes. The velocity of the second drum can be higher than the velocity of the first drum.

The present invention, also provides a method for producing aligned nanotubes. The method includes producing a volume of nanotubes within a pathway, directing the volume of nanotubes downstream along the pathway through a constrained region, and subsequently deflecting the nanotubes moving through the constrained region into substantial alignment relative to one another. In some embodiments, the volume of nanotubes is free-flowing. The aligned nanotubes can be further collected from the pathway about a rotating anchor for subsequent stretching and further alignment.

In one embodiment, the volume of nanotubes downstream is directed along the pathway through a constrained region that includes one of a tapered section of the pathway, a conical section of the pathway, or both. In some embodiments, the method further includes directing a flow of gas circumferentially about the volume of nanotubes in the constrained region to minimize adherence of the nanotubes to the pathway.

In another embodiment, the volume of nanotubes is directed along the pathway through a constrained region that includes one or more discs, each having at least one orifice with a diameter smaller than that of the pathway, and through which the volume of nanotubes can flow. Each successive disc can include a successively smaller orifice to further constrain the volume and align the nanotubes.

In another embodiment, the volume of nanotubes is directed along the pathway through a constrained region that includes one or more electrostatic lenses that can generate an electrostatic field. Each successive electrostatic lens can have a different voltage from the adjacent lens to further constrain the volume and align the nanotubes.

In some embodiments, the method includes accelerating the volume of nanotubes directed along the pathway through the constrained region to counteract randomization of the nanotubes within the volume.

In another embodiment, the step of directing can include rotating on a substrate the volume of nanotubes onto which the volume of nanotubes is affixed.

### BRIEF DESCRIPTION OF DRAWINGS

FIG. 1A illustrates a system for fabricating nanotubes and nanotube sheets, in accordance with one embodiment of the present invention.

FIG. 1B illustrates a cross-section of the nanotube sheet in accordance with one embodiment of the present invention.

FIGS. 2A-2B illustrates a system of the present invention for formation and harvesting of nanotubes. FIG. 2A is an overall illustration of the closed system. FIG. 2B is an illustration of the system with the door open for harvesting.

FIG. 3 illustrates a system for aligning carbon nanotubes generated from a volume or cloud of free-flowing nanotubes according to one embodiment of the present invention.

FIG. 4A is a schematic diagram of a system according to one embodiment of the present invention, using aerodynamic lenses to align nanotubes.

FIG. 4B illustrates a device having multiple aerodynamic lenses, according to another embodiment of the present invention.

FIG. 5 illustrates an internal anchor configuration according to one embodiment of the present invention.

FIG. 6A-B is a schematic diagram of a collection system in accordance with some embodiments of the present invention.

FIG. 7A-C is a schematic diagram of a collection system in accordance with some embodiments of the present invention.

FIG. 8A-B is a schematic diagram of an electrostatic lens system in accordance with one embodiment of the present invention. FIG. 8C is a photograph of a three dimensional structure at an early stage of formation, according to one embodiment of the present invention.

FIG. 9 illustrates the fixed catalyst CNT growth system according to one embodiment of the present invention.

FIG. 10A is a schematic diagram of a horizontal anchor arrangement used with a system for aligning CNTs according to one embodiment of the present invention.

FIG. 10 B illustrates the breaking stress of the nanofibrous material according to one embodiment of the present invention.

### DESCRIPTION OF SPECIFIC EMBODIMENTS

Nanotubes for use in connection with the present invention may be fabricated using a variety of approaches. Presently, there exist multiple processes and variations thereof for growing nanotubes. These include: (1) Chemical Vapor Deposition (CVD), a common process that can occur at near ambient or at high pressures, and at temperatures above about 300° C., (2) Arc Discharge, a high temperature process that can give rise to tubes having a high degree of perfection, and (3) Laser ablation. Other methods, such as plasma CVD or the like are also possible. It is understood that boron nanotubes may also be growth in a similar system but with different chemical precursors. It should be noted that although reference is made below to nanotube synthesized from carbon, other compound(s) may be used in connection with the synthesis of nanotubes for use with the present invention.

The present invention, in one embodiment, employs a CVD process or similar gas phase pyrolysis procedures known in the industry to generate the appropriate nanostructures, including nanotubes. In particular, since growth temperatures for CVD can be comparatively low ranging, for instance, from about 300° C. to about 1400° C., carbon nanotubes, both single wall (SWNT), dual wall (DWCNT) or multiwall (MWNT), may be grown. These carbon nanotubes may be grown, in an embodiment, from nanostructural catalyst particles introduced into reagent carbon-containing gases (i.e., gaseous carbon source), either by addition of existing particles or by in situ synthesis of the particles from, for instance, a metal-organic precursor, or even non-metallic catalysts. Although both SWNT, DWCNTs, and MWNT may be grown, in certain instances, SWNT may be preferred for some applications because of their higher growth rate and their tendency to form ropes which may offer handling, safety and strength advantages. It should be noted that hereinafter the terms “carbon nanotubes” or “CNTs” can be used interchangeably to refer to carbon nanotubes.

### System for Fabricating Sheets and Yarns

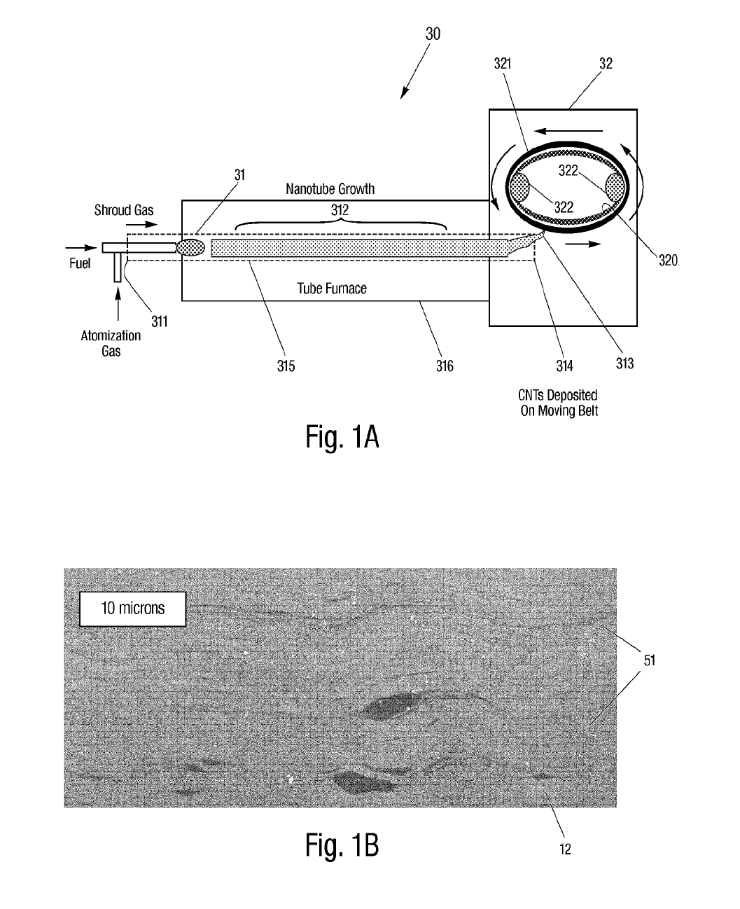

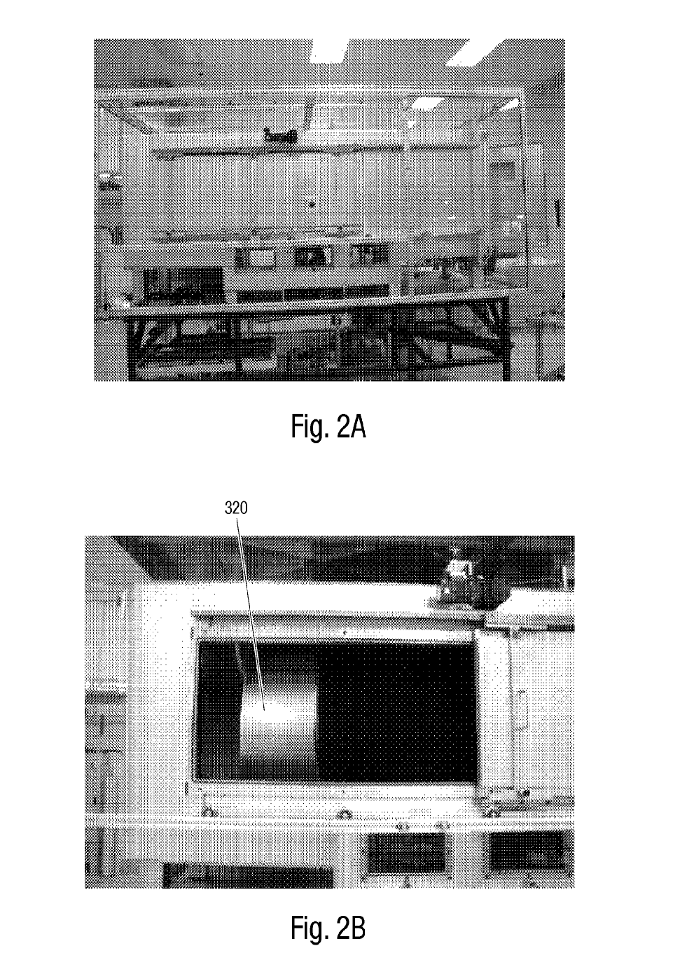

With reference now to FIG. 1A, there is illustrated a system 30, similar to that disclosed in U.S. Pat. No. 7,993,620 (filed Jul. 17, 2006; incorporated herein by reference), for use in the fabrication of nanotubes. In particular, FIG. 1A is a schematic diagram of the CVD furnace showing from the left to the right, an injector, growth area and take up belt. System 30, in an embodiment, may include a synthesis chamber 31 within which CNT growth occurs. The synthesis chamber 31, in general, includes a fuel injector positioned at an entrance end 311 and through which reaction gases (i.e., gaseous carbon source) may be supplied, with catalysts or catalyst precursors, into the synthesis chamber 31. The synthesis chamber 31 may also include a hot zone 312, where synthesis of nanotubes 313 may occur, and an exit end 314 from which the products of the reaction, namely a cloud of nanotubes and exhaust gases, exit and be collected. The synthesis chamber 31, in an embodiment, may include a quartz tube, or a ceramic tube such as mullite or a metallic tube such as FeCrAl tube 315 extending through a furnace 316. The nanotubes generated by system 10, in one embodiment, may be individual single nanotubes (each may be a SWCNT, DWCNT or MWCNT), bundles of such nanotubes, and/or intermingled or intertwined single-walled nanotubes, all of which may be referred to hereinafter as “non-woven.”

System 30, in one embodiment of the present invention, may also include a housing 32 designed to be substantially fluid (e.g., gas, air, etc.) tight or hermetically sealed, so as to minimize the release of potentially hazardous airborne particulates from within the synthesis chamber 31 into the environment. The housing 32 can also act to prevent oxygen from entering into the system 30. In particular, the presence of oxygen within the synthesis chamber 31 can affect the integrity and can compromise the production of the nanotubes 313.

System 30 may also include a moving belt 320, positioned within housing 32, designed for collecting synthesized nanotubes 313 generated from within synthesis chamber 31 of system 30. In particular, belt 320 may be used to permit nanotubes collected thereon to subsequently form a substantially continuous extensible structure 321, for instance, a CNT sheet. Such a CNT sheet may be generated from substantially non-aligned, non-woven nanotubes 313, with sufficient structural integrity to be handled as a sheet. Belt 320, in an embodiment, can be designed to translate back and forth in a direction substantially perpendicular to the flow of gas from the exit end 314, so as to increase the width of the CNT sheet 321 being collected on belt 320. Alternatively this belt can be replaced with a large drum.

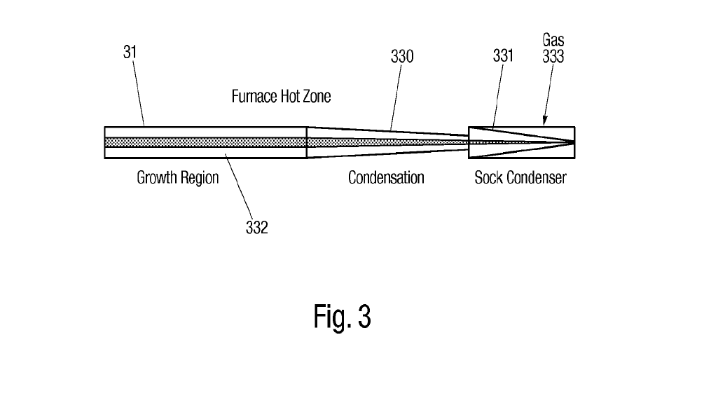

To collect the fabricated nanotubes 313, belt 320 may be positioned adjacent the exit end 314 of the synthesis chamber 31 to permit the nanotubes to be deposited on to belt 320. In one embodiment, belt 320 may be positioned substantially parallel to the flow of gas from the exit end 314, as illustrated in FIG. 1A. Alternatively, belt 320 may be positioned substantially perpendicular to the flow of gas from the exit end 314. In one embodiment, belt 320 can be designed to translate from side to side in a direction substantially perpendicular to the flow of gas from the exit end 314, so as to deposit layer by layer on the belt or drum to generate a large sheet that is substantially wider than the exit end 314. Belt 320 may also be designed as a continuous loop, similar to a conventional conveyor belt, such that belt 320 can continuously rotate about an axis, whereby multiple substantially distinct layers of CNT can be deposited on belt 320 to form a sheet 321. To that end, belt 320, in an embodiment, may be looped about opposing rotating elements 322 and may be driven by a mechanical device, such as an electric motor. Alternatively, belt 320 may be a rigid cylinder, such as the drum shown in FIG. 2B. In one embodiment, the motor may be controlled through the use of a control system, such as a computer or microprocessor, so that tension and velocity can be optimized. The deposition of multiple layers of CNT in formation of sheet 321, in accordance with one embodiment of the present invention, can result in minimizing interlayer contacts between nanotubes. Specifically, nanotubes in each distinct layer of sheet 321 tend not to extend into an adjacent layer of sheet 321. As a result, normal-to-plane thermal conductivity can be minimized through sheet 321.

To disengage the CNT sheet 321 of intermingled non-woven nanomaterials from belt 320 for subsequent removal from housing 32, a blade (not shown) may be provided adjacent the roller with its edge against surface of belt 320. In this manner, as CNT sheet 321 is rotated on belt 320 past the roller, the blade may act to lift the CNT sheet 321 from surface of belt 320. In an alternate embodiment, a blade does not have to be in use to remove the CNT sheet 321. Rather, removal of the CNT sheet may be by hand or by other known methods in the art.

Additionally, a spool (not shown) may be provided downstream of blade, so that the disengaged CNT sheet 321 may subsequently be directed thereonto and wound about the spool for harvesting. As the CNT sheet 321 is wound about the spool, a plurality of layers of CNT sheet 321 may be formed. Of course, other mechanisms may be used, so long as the CNT sheet 321 can be collected for removal from the housing 32 thereafter. The spool, like belt 320, may be driven, in an embodiment, by a mechanical drive, such as an electric motor (or stepping motor), so that its axis of rotation may be substantially transverse to the direction of movement of the CNT sheet 321.

In order to minimize bonding of the CNT sheet 321 to itself as it is being wound about the spool, a separation material may be applied onto one side of the CNT sheet 321 prior to the sheet being wound about the spool. The separation material for use in connection with the present invention may be one of various commercially available metal sheets, papers, or polymers that can be supplied in a continuous roll. To that end, the separation material may be pulled along with the CNT sheet 321 onto the spool as sheet is being wound about the spool. It should be noted that the material comprising the separation material may be provided in a sheet, liquid, or any other form, so long as it can be applied to one side of CNT sheet 321. Moreover, since the intermingled nanotubes within the CNT sheet 321 may contain catalytic nanoparticles of a ferromagnetic material, such as Fe, Co, Ni, alloys etc., the separation material, in one embodiment, may be a non-magnetic material, e.g., conducting or otherwise, so as to prevent the CNT sheet from sticking strongly to the separation material. In an alternate embodiment, a separation material may not be necessary. After the CNT sheet 321 is generated, it may be left as a CNT sheet or it may be cut into smaller segments, such as strips, using methods known in the art.

A system suitable for use in accordance with the present invention is shown in FIGS. 2A-2B. The CNT material produced by such system can be collected as a non-woven sheet on a moving belt 320 or drum. The carbon nanotubes 14, in an embodiment, can be deposited in multiple distinct layers 51 to form a multilayered structure or morphology in a single CNT sheet 12 (FIG. 1B). In some embodiments, the CNT sheet can have a low normal-to-plane or through-thickness electrical conductivity, which may result from inter-tube resistance as well as a low thermal conductivity normal to the plane for the same reasons.

A system similar to system 30 may also be used for manufacturing nanotube yarns. To manufacture yarns, housing 32 can be replaced with an apparatus to receive nanotubes from the furnace 316 and spin them into yarns. Such a system is disclosed in U.S. Pat. No. 7,993,620, which is incorporated herein by reference. The yarn generated, in one embodiment, may be fully spun with a well-defined twist angle or simple be given a false twist and collected on a bobbin.

The CNT sheet or yarn generated by the system of the present invention can be subsequently used in various applications.

### I. In Situ Nanotubes Alignment

It should be noted that the properties of carbon nanotubes (CNTs) can be governed by structural properties of the carbon nanotubes, such as defects, length, diameter and chirality, and overall tube-bundle alignment or morphology. Alignment of CNT products such as in yarns or sheets historically has been accomplished after fabrication. Even though post process alignment can enhance strength and other properties, and can provide substantial macro alignment, post-process alignment may not be capable of achieving, in certain instances, alignment at the nanoscale and may add extra cost to the process of yarn synthesis, or tape synthesis.

Aspects of the invention relate to the in-situ methods, systems and apparatus for carbon nanotube alignment in order to achieve a substantially precise organization of the nanotubes on the nanoscale (e.g. about 1 to about 10 nm scale). In some embodiments, the alignment of the nanotubes in the resulting CNT material of the present invention, e.g., sheet or yarn, may be greater than 90%, for example, as measured by x-ray. In some embodiments, the strength of the CNT material of the present invention may be above about 5 GPa, for example, as measured at 5 cm gauge length. In some embodiments, the modulus of the CNT material of the present invention may be greater than about 150 GPa, and potentially, when in the aligned state, near a theoretical values of near 600 GPa. In some embodiments, the electrical conductivity of the CNT material of the present invention has been measured to be greater than 3×10⁶ S/m, and potentially, when in the aligned state, might achieve values near or above copper, that is, greater than 60×10⁶ S/m . In some embodiments, the thermal conductivity of the CNT material of the present invention has been measured to be greater than 100 W/m.° K and may be much higher in the aligned state. In some embodiments, the CNT material of the present invention may have thermoelectric properties, for example, about 300 μV/° K or higher.

In some embodiments, the synthesis chamber 31, as described above, can be designed and/or modified to allow for provide one or more alignment pathways. In some embodiments, the alignment pathways may include, but is not be limited to, (i) flow alignment, such as gas flow alignment, (ii) electrostatic alignment of the CNTs, (iii) fixed mechanical alignment or any combinations thereof. In some embodiments, gas velocities can be manipulated to achieve alignment before condensation of the free-flowing cloud of CNTs into a bulk material, thereby substantially eliminating any post process alignment procedures.

In some embodiments, alignment may be coupled with a plasma generator, as disclosed in copending U.S. application Ser. No. 13/560,582 filed 27 Jul. 2012 that can be used in the generation of CNTs.

It should be appreciated that superficial alignment at a nanoscale level can be measured by image analysis of high magnification SEM images, by Polarized Raman spectroscopy, or by x-ray diffraction using a planar detector.

1. In Situ Flow Alignment

In an embodiment of the present invention, various apparatuses and gas flow schemes can be used to align CNTs in the synthesis chamber 31 of furnace 316 (i.e., in situ alignment) prior to collection of the CNTs to assist in the alignment of the CNTs for collection. In particular, a highly aligned “jet” of CNTs can be generated from the flow (i.e., cloud) of CNTs from within the furnace 316, and such aligned flow of CNTs can be manipulated to achieve substantial alignment before condensation of the CNT flow or cloud into a matrix of bulk material upon its exit from the synthesis chamber 31 of furnace 316. In an embodiment, the matrix can resemble a “sock” structure having a substantially hollow interior.

In some embodiments, flow alignment of CNTs may be implemented, but is not limited to tapering or converging the flow of CNTs through, for example, (i) the use of a tapering synthesis chamber 31 and/or a conical apparatus positioned in the flow path of the CNTs within the synthesis chamber 31, (ii) the use of aerodynamic lens, (iii) the formation of a jet of aligned small diameter CNTs, (iv) the use micro-furnace, or (v) any other apparatus suitable for accelerating gas flow around a carbon nanotube or tube bundle.

It should be noted that the flow CNTs, in a hot zone 312 of the synthesis chamber 31, may be a loose suspension or cloud of nanotubes and/or bundles suspended in the gas phase. This flow can move around obstructions and sticking can be minimized to walls of the synthesis chamber 31. In addition, as the temperature of the CNT flow drops, for instance, at a location past a mid-point of the synthesis chamber 31, the flow of the CNT cloud may slow, which can apply forces on the cloud of CNT material to compress, which can introduce some disorder. Upon movement of the cloud of CNT material out of the hot zone 312, these compressive forces can become stronger and more dramatic condensation and randomization of the CNT flow can occur, resulting in a matrix of connected CNTs with aerogel-like properties.

It should be appreciated that since the cooling can also occur from the walls of the synthesis chamber 31, the center of synthesis chamber 31 may be relatively hotter, thus causing the cloud of CNTs to move faster. This can result in a radial density gradient, where the center of the cloud of CNTs is less dense than the outer part of the cloud of CNTs. It should also be noted that the CNTs may stick to any surface that is cooler. Accordingly, any alignment achieved in the synthesis chamber 31 of furnace 316 would need to be maintained as the CNTs is cooled and collected. Accordingly, the CNTs , in one embodiment, may be kept away from surfaces that are relatively cooler than the temperature of the cloud of CNTs.

As noted, the cloud of CNTs may form a three-dimensional network or matrix (i.e. a sock shaped matrix) in the synthesis chamber. In an embodiment, the alignment of nanotubes within matrix used to form a CNT sheet was measured by polarized Raman, as well as by X-ray, and found to be random. In applications where anisotropy is beneficial such as structural fiber composites, the near-finished CNT yarn or sheet can subsequently be stretched post-formation in order to further enhance axial alignment of the constituent fibers within the yarn or sheet at least at a macroscale level. In some embodiments, the CNT alignment processes disclosed herein can yield to tensile strength improvement of from about 1.5 Gpa to several times this value.

In some embodiments, by predicting and/or controlling the location in the furnace tube where the cloud of floating CNTs can agglomerate, and by accelerating the flow over the length of that region, it may be possible to constrain the loose CNTs into a preferentially-axial orientation while allowing the CNTs assemble due to their normal electrostatic interaction. In some embodiments, gains in alignment on the microscopic scale can be further multiplied by later post-processing steps described herein and in copending application Ser. No. 12/170,092. Significant alignment of the CNT bundles on the nanoscopic or microscopic scale can dramatically improve the strength, thermal and electrical conductivity.

a. Bulk Flow Acceleration (Conical Flow)

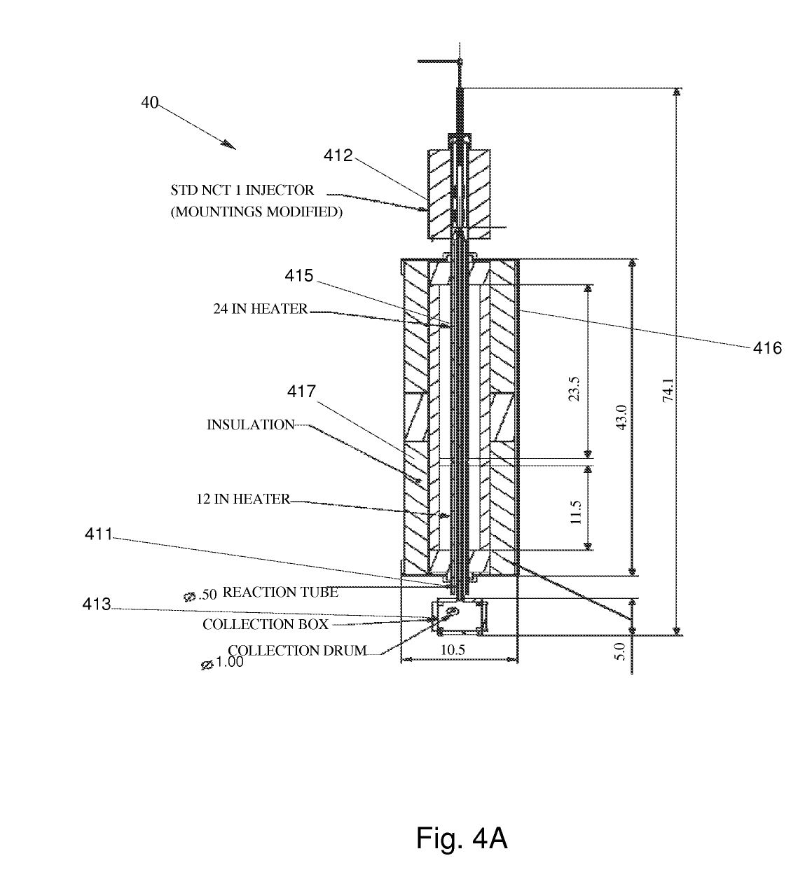

Looking now at FIG. 3, one approach to in situ flow alignment includes tapering of a region 330 along synthesis chamber 31 of furnace 316 in a region of cooling where the CNTs agglomerate, or condense, for instance downstream of growth region 332 along a hot zone of synthesis chamber 31 (injector not shown). As a result, acceleration of the flow of cloud of CNT material through such a cooling or condensation region 330 (i.e., acceleration field) can be induced, thereby promoting alignment of the CNTs. It should be appreciated that there can be several approaches to creating a tapered conical flow field, so long as there is a reduction in diameter of the synthesis chamber 31 along the tapered region 330.

To further enhance acceleration of the CNT flow through the acceleration field, in one embodiment, a cone-like apparatus or other conical similar apparatuses, such as cone 331 may positioned within the flow of the cloud of CNT material. In an embodiment, cone 331 may be positioned downstream of the tapered region 330, and may be made from refractory material and can be placed within an area where the CNT material begins to coalesce or agglomerate. As illustrated in FIG. 3, on the left, the tapered reaction tube region 330 of synthesis chamber 31 of furnace 316 can act to allow for the acceleration of the CNT flow throughout the region of cooling (i.e., acceleration field). On the right of FIG. 3, cone 331 may be used to further enhance alignment of the CNTs. In some embodiments, gases 333 may be radially introduced about the tapered region 330 or cone 331 to aid with the prevention of fouling or to minimize the occurrence of CNTs sticking to the walls of region 330 or cone 331, as well as to further enhance alignment. This can be done, in some embodiments, by providing perforations (not shown) circumferentially about region 330 or cone 331. In some embodiments, the length and shape of the region 330 or cone 331, as well as the geometry and volume of gas introduction can be changed to optimize alignment.

It should be appreciated that in some cases, the acceleration fields provided by the tapered region 330 and/or cone 331 within synthesis chamber 31 may be sufficient to completely align CNTs. To the extent that the CNTs may not be substantially completely aligned, this may be a result if the moment resulting from the gas acceleration is not strong enough to counteract randomizing forces. In either case, alignment may be improved by the use of a tapered region 330 and/or cone 331.

b. Aerodynamic Lens

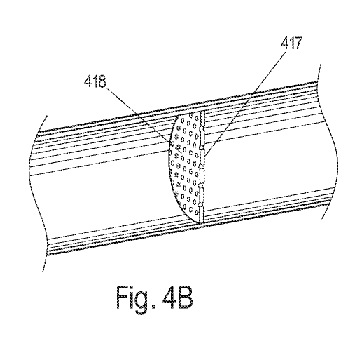

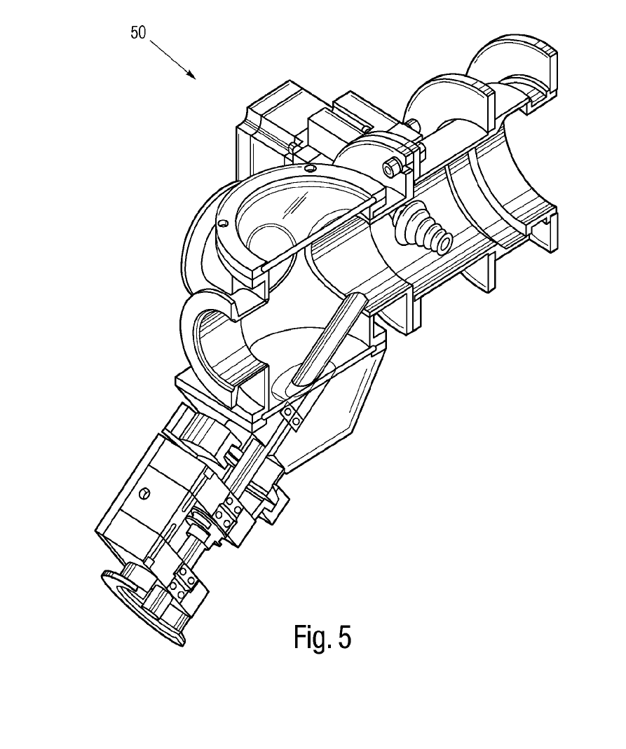

Looking now at FIGS. 4A-B, another approach to in situ flow alignment includes the use of an aerodynamic lens system 40 within modified a furnace 416. As illustrated in FIG. 4A, the aerodynamic lens system 40 may be a vertical tube furnace 416 within which a tube synthesis chamber 411 may be situated and may extend along the length of the furnace 416. The synthesis chamber 411, in some embodiments, can be made of ceramic, such as alumina-zirconia. The synthesis chamber 411, in some embodiments, can have a diameter up to ¾ inch. Of course, depending on the application, the diameter of the chamber 411 can be adjusted upward from ¾ inch or downward, as necessary. In some embodiments, the system 40 may include a fuel injector 412 located on top of the furnace 416, a harvesting chamber 413 located at the bottom of the furnace 416 and two hot zones, each heated by heater 415. Although shown as a vertical tube furnace, it should be appreciated that furnace 416 may alternatively be a horizontal tube furnace.

System 40, in one embodiments of the present invention can also include an insulator 417 to prevent dissipation of heat provided by heaters 415. Heaters 415, in one embodiment, may be a dual zone spiral SiC heaters situated within the hot zones about synthesis chamber 411. Heaters 415, in some embodiments, can generate a temperature ranging from about 1150 to about 1300° C. sufficient to generate CNTs. In an exemplary embodiments, the temperature of the heaters 415 may be about 1250° C. In some embodiments, the operational vertical tube furnace 416 can further comprises an injector 412, a heated flow condensing mechanism to prevent sticking of the CNT to the furnace's walls, and a rapid harvesting chamber 413. The furnace 416 can further have a safety system that can include a blow out membrane that can fail before any other components of the system to release pressure that might cause an explosion. Although illustrated as such in FIG. 4B, it should be appreciated that other configurations may be employed.

Referring to FIG. 4B, system 40 can include one lens 417 (as shown) or more than one lens (not shown) inserted along the length of tube 411 to align tubes and/or bundles of tubes within the flowing cloud of CNTs. In one embodiment, the lens 417 may be an aerodynamic lens and may a disc with an orifice 418 through which the cloud of nanotubes may flow. Although described as having one orifice 418, lens 417 may include a plurality of orifices, as shown in FIG. 4B. To the extent more than one lens 417 is used, the lenses may be in linear alignment along synthesis chamber 411, and each successive downstream lens 417 may include a successively smaller diameter orifice 418, so as to force or condense the flowing cloud of CNTs toward a smaller radial volume, while moving the CNTs substantial axial alignment with tube 411. The successive orifices 418 can also be used control the flow acceleration or deceleration, allowing the nanotubes to radially condense toward a filament like shape. Such an approach toward condensing the flow of CNTs can force the CNTs to be in closer proximity to enhance contact between adjacent nanotubes. Contacts between adjacent CNTs can be further enhanced via non-covalent interactions between the CNTs, such as London dispersion forces or van der Waals forces.

Still referring to FIG. 4B, aerodynamic lens 417 may be made from a refractory material. In some embodiments, the diameter of the orifice 418 can be tuned to a specific particle size and carrier gas flow rate. It should be noted that nanotubes build up at the lens 417 may disturb the flow. This may be mitigated by thermophoretic forces obtained by heating the lens 417 and/or by angling lens 417 to the gas flow through orifice 418. In some embodiments, one or more lenses 418 having different apertures can be used. Once a substantially condensed flow of CNTs is obtained resembling a yarn, for example, it can be spun using yarn spinning concepts.

Long injector, such as injector 412 shown in FIG. 4A, may be used to extend into the hot zone of furnace 416. However, the injector 412 may very quickly become clogged with carbonaceous material. Coking, in various embodiments, therefore can be controlled and/or prevented. In one approach, the entrance to the furnace 416 can be located downstream of the “coking” region.

It should be noted that if the entrance to the furnace 416 is too far downstream, the CNT material can build up at the entrance and clog the furnace 416. In various embodiments, fouling can be controlled and/or prevented. For example, to control fouling, the entrance may be located in the hot zone of the furnace 416.

It should be appreciated that if the CNTs contact a relatively cool surface, one that is below about 1000° C., they tend to stick to such a surface. In some embodiments, upstream fouling can be controlled and/or prevented. For example, upstream fouling can be mitigated through thermal and flow adjustment. Because the lens 417 or series of lenses can be placed where the CNTs just start to grow, the lens or series of lenses can have orifices with diameters of a certain size. In certain instances, clogging can occur if the diameter of the orifice 418 is about 5 times the length of the CNTs passing through. However, at the early stages of growth, CNT length can be very short, so that as growth proceeds, the diameter of the orifice 418 in the series of lenses, in some embodiments, can be adjusted to minimize clogging.

In some embodiments downstream fouling can be controlled and/or prevented. The CNT material of the present invention may be cooled to about 400° C. before exiting the furnace and entering the collection region a described below.

According to some aspects of the invention, a microreactor furnace employing a plurality of small tubes (such as small tube furnace 416) in substantial parallel alignment can be used to enhance aligned CNT production volume. Tube diameter in such a microreactor furnace can be selected so as to minimize clogging of the small tubes with carbon. In some embodiments, the initial starting tube diameter may be about 5 times the expected tube length, or about 50 mm. In some embodiments, reducing the diameter of the small tubes can potentially induce a number of beneficial effects. As the positional and orientation freedom of the CNTs is reduced, CNTs may agglomerate into a more aligned material without any added flow control apparatus. Also, the boundary layer in a small tube can cause a significant velocity gradient in the radial direction. The resulting shear forces tend to draw particles to the center (Saffman Lift Force). This may compress and agglomerate CNT material in an axially aligned geometry. This may also improve heat transfer on a small diameter furnace tube.

c. In Situ Alignment Collection System

It should be noted that assuming that in-situ alignment is successful, this alignment may be maintained as the material exits the furnace. As described previously, the cooling of the gas can create compression forces on the CNT material which can randomize the tube orientation. This issue, in some embodiments, is addressed with a condensing mechanism, such as a heated cone 331 (FIG. 3) and optionally radially introduced gas flow that can keep the CNT material away from the walls, and accelerates the material as it cools down

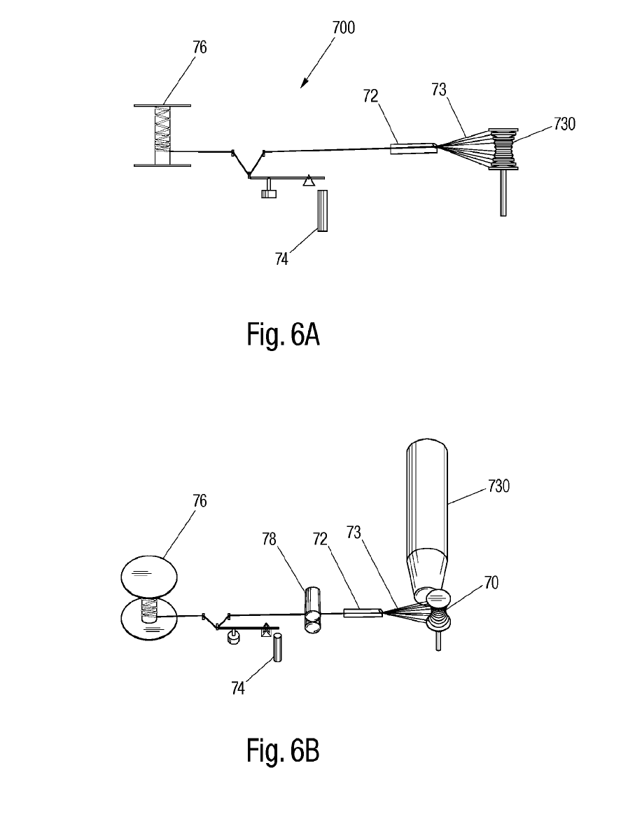

In operation, under steady state production of the nanotubes, and according to some embodiments of the present invention, the nanotubes may be collected from within the synthesis chamber 31 through the use of, for example, anchor 50 shown in FIG. 5. and a yarn may be formed. Anchor 50, in an embodiment, can be placed inside the synthesis chamber 31, preferably in the cooling region of the synthesis chamber 31. In some embodiments, anchor 50 may be placed substantially perpendicular to the flow of CNTs. As the CNTs are collected, they may be gathered or bundled as they emerge from the synthesis chamber. It should also be noted that even if CNT alignment is maintained until exiting the furnace, the CNTs may sometimes end up being randomized in the collection process to maintain alignment. In one embodiment, upon exit, the CNTs may be captured by a slowly rotating external anchor as part of a collection system 700, as will be described below.

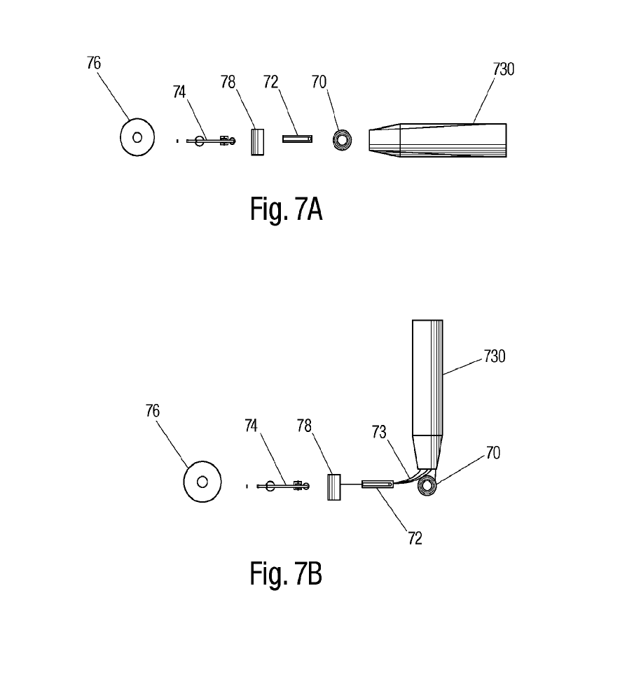

With reference now to FIGS. 6A-B and 7A-C, in some embodiments, collection system 700 may include a number of subsystems. System 700 can include, according to some embodiments an external anchor 70, positioned adjacent an exit of synthesis chamber 730, which serves to hold the CNTs exiting from furnace 730 so that the CNTs can be stretched or aligned. The anchor 70, according to some embodiment, can spin at constant velocity.

Referring now to FIG. 6A-B, the collection system 700 can include, in some embodiments, a wiggle tube 72 designed such that its surface can help debond or release the CNTs 73 from the anchor 70.

In some embodiments, the system 700 further includes a combination of a dancer 74 and a take up bobbin 76 to control the yarn motion. Pinch roller 78 may also be provided and may operate at a substantially constant speed to pull the yarn of CNTs from the anchor 70 at a constant rate. As illustrated in FIG. 6B, when used in a configuration with a dancer 74, the pinch roller 78 can control the velocity from the anchor 70 through the wiggle tube 72 while the dancer 74 can control the tension between the bobbin 76 and the pinch roller 78. In some embodiments, the collection system 700 can include an anchor 70, a wiggle tube 72, a dancer 74 and a take up bobbin 76 without the pinch roller, as shown in FIG. 6A. In such a configuration, the dancer 74 can control the entire collection system 700.

Although shown as having a concave geometry, the external anchor 70 may have a convex or a cylindrical geometry. Notches or slots may be provided circumferentially about the anchor 70 to serve as an anchor area for CNTs 73 exiting the furnace 730. In that way, the external anchor 70 can restrain the CNTs while pulling on the CNTs 73 to align them. In some embodiments, the anchor 70 can be made of serrated disks made of stainless steel. In some embodiments, the geometry of the anchor 70 is designed to cause the CNTs to stick in selected places.

The dancer 74, in accordance with certain embodiments, can act to keep the tension in the yarn of CNTs 73 substantially constant no matter what happens elsewhere in the system 700. The dancer 74, in one embodiment, can be electrically connected to the bobbin 76 though a PID controller (not shown). The take up bobbin 76 can speed up or slow down to keep the dancer 74 in the same position. The dancer 74, in one embodiment, can include a tensioned pivot. In such a configuration, the static weight can control the tension of the yarn of CNTs 73 and the PID controller can control the speed of the take up bobbin 76. If there is a transient tension problem, the dancer 74 can compensate by supplying more yarn of CNTs 73 to the collection system 700 thereby relieving the tension so the yarn of CNTs 73 will not break. In an embodiment, the position sensor can act to slow the take up bobbin 76 down until the transient tension problem goes away.

In some embodiments, the wiggle tube 72 can be made of stainless steel and can be caused to spin at a substantially constant velocity. The wiggle tube 62 may be designed to have an eccentric hole (i.e., off-centered hole). The yarn of CNTs 73, in an embodiment, can be fed through the wiggle tube 72 through an eccentric hole, so that as the wiggle tube 72 rotates, it applies a small force coaxing the yarn of CNTs 73 to gently separate from the anchor 70.

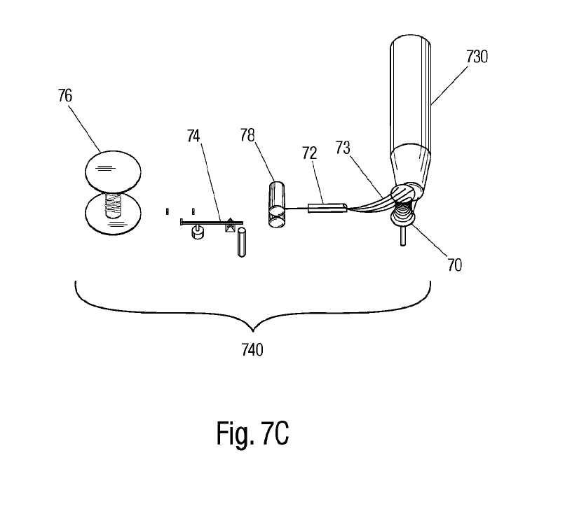

Looking now at FIGS. 7A-C, in some embodiments, anchor 70 may be placed in such a way that the flow of CNTs 73 carries the CNTs past the anchor 70. In such an embodiment, anchor 70 may rotate counter to the flow so that alignment of the CNTs 73 collected by anchor 70 Implementation of this scheme can ensure that flow of CNTs aligned in the furnace 730 stays oriented when collected by anchor 70. In some embodiments, an in-line collection anchor can be used. FIG. 7A is a schematic diagram of a straight through design. FIGS. 7 B-C are a schematic diagram of a configuration with the anchor 70 to the left of the tube furnace 730 and the take up system 700 at 90 degree angle to the left of the furnace.

In some cases, anchor 70 may not be used to catch or collect the flow of CNTs 73 exiting furnace 730. To that end, other mechanisms may be used to catch the flow of CNTs 73 exiting the furnace 730. For example, the flow of CNTs 73 may be collected on a belt or drum, similar to the sheet systems described above.

Various features, apparatus, and methods may be used in the various embodiments, including but not limited to, a bulk flow acceleration CNT reactor, an aerodynamic lens based CNT reactor, a microtube furnace, a collection system that maintains CNT alignment developed in the furnace, a 3 inch tube furnace, and/or a method of improving material alignment in the collection system that may include, but not limited to, stretching, carding, lubricating, and/or chemically treating the material.

2. Electrostatic Alignment

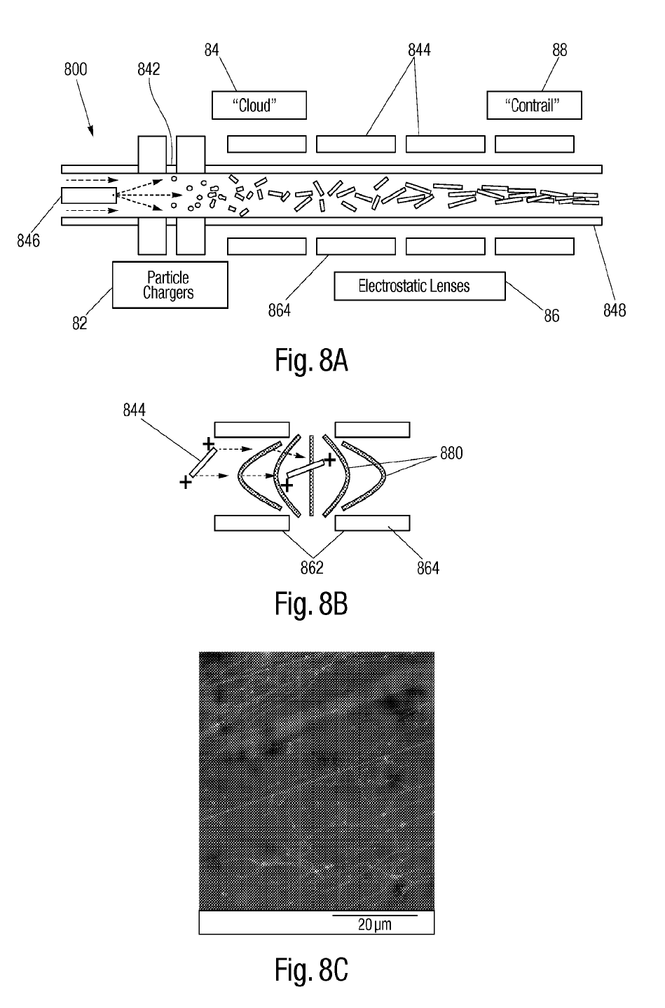

The flow of CNTs, in some embodiments, may be electrostatically aligned using, for example, electrostatic lens system 800, as shown in FIGS. 8A-B. As shown, system 800 may employ electrostatic lenses 86 to align the CNTs 844. In certain embodiments, electrostatic alignment may be coupled with a plasma generator as described in copending U.S. application Ser. No. 13/560,582 filed 27 Jul. 2012. In one embodiment of the present invention, the electrostatic lens system 800 can use one of several particle charging technologies, such as particle charger 82, to place an electric charge on newly formed catalyst particles and on nanotubes 844 in early stage growth. The charging process may be accomplished by UV, soft X-ray photo-emission, friction, naturally during growth or possibly other means or combinations thereof, bearing in mind that the reactor is operating with gas pressure close to atmospheric levels. Alternatively, due to the dipole effects, an electrostatic field 880 can also serve to align tubes parallel to the field lines without charging the nanotubes 844. In some embodiments, the tubes may not be charged. The tubes may or may not be charged.

As the elongating nanotubes 844 flow along the furnace prior to condensation, the nanotubes may encounter an array of electrostatic lenses 86. The electrostatic lenses 86, in one embodiment, can act to focus the flow of CNTs into a denser and smaller diameter cloud, and can also serve to align the CNTs. The lens 86 can also act to push each point of each charged tube 844 toward the axis of the furnace.

As illustrated in FIGS. 8 A-B, particles 842 from which CNTs grows can be charged by particle charger 82. Once past the charger 82, particles 842 encounter electrostatic lenses 86. In one embodiment, the lenses 86 can be co-axial, closely spaced, conducting cylinders 864 held at different voltages. In a gap region 862 between two of these cylinders 864, there can be large and rapidly varying electric fields which exert a significant force on charged particles 842 passing through the gap region 862, such that the magnitude and direction of the force vary with the radial position of the particle 862. As CNTs 844 grow they may be multiply charged by the ejection of more than one electron. The lens 86, in an embodiment, is constituted of the region of electric field 880. Field 880, as shown in FIG. 8B, represent isopotential planes that fills the gap region 862 between two adjacent conducting cylinders 864 held at different voltages. In some embodiments, the lens field strength and position can be optimized to align the CNTs. It should be noted that although lenses 86 are shown with multiple conducting cylinders 864, system 800 may be provided where only one conducting cylinder 864 is used.

In some embodiments, the electrostatic lenses 86 can function analogously to optical lenses. Charges can be deflected by an amount proportional to the angle their initial velocity makes with equal potential surfaces. With properly designed lenses, a torque that aligns the CNTs with the axis of the furnace, in addition to packing them into the axis of the tube can be generated.

As CNTs 844 grow from particles 842, they can form a cloud 84, which subsequently can be compressed by electrostatic lenses 86 into a contrail 88 having an appropriate density. A three dimensional structure can be formed, in one embodiment, analogous to a spider web with radial arms forming from catalysts sticking to initially created CNTs. FIG. 8C is a photograph of early stage formation of such a three dimensional structure. In particular, the early formed extended length CNTs shown in FIG. 8C can provide a place to which catalysts can adhere. Small thin tubes can then grow from theses newly adhered catalyst. The late comers act to bind the structure together into a spider-like web.

It some embodiments, an anchor system, as described above, can be used to convert the contrail into a thread. In some embodiments, such process allows for the production of improved thread with greater alignment, higher density, and strength.

In some embodiments, the charging of the catalyst particles can be optimized so as not to interfere with the CNT growth process. In some cases, the end of CNT growth might occur closer to the injector 846, because the growing CNTs are compressed into a smaller volume and fuel starvation can become more of a problem. In other cases, all particles will not become charged, and some catalyst particles might remain further away from the axis of tube 848, and can evolve to form matrix of interconnected CNTs. At some levels of partitioning of catalyst particles between the contrail and the matrix of CNTs, the average density of growing CNTs might be lowered, which might extend the growth zone further down the length of the furnace tube. The matrix of CNTs and the contrail might or might not be linked by CNTs spanning regardless of whatever gap forms. Accordingly, in some embodiments, such interference can be minimized.

In some embodiments, the proportion of charged catalysts particles can be controlled and/or optimized. In some cases, high fluxes of penetrating UV radiation or even soft X-rays to ionize catalyst particles can be applied.

In some embodiments, the electrostatic lenses designed to compress or align the CNTs may function at very low pressures (micro-Torr). At higher pressures there might be a significant stokes drag force on the aerosol particles, which can fundamentally change the dynamics of the lens system. However, it is clear that particles can retain their electric charge for periods of many seconds, and can have significant forces imposed on them by electrostatic means. At low pressures these beams are often formed by aerodynamic lenses in which a stream of molecules is allowed to stream from an atmospheric source, through appropriate apertures, into a region of low pressure as described in the aerodynamic lens concept.

In the simplest case, the strength of an electrostatic lens can be found by equating the electrostatic force with the hydrodynamic (or aerodynamic) Stokes drag. The gravitational and thermophoretic forces can be neglected, and the density of charged particles is assumed to be low enough that Coulomb interactions with surrounding neighbors can be neglected.

$$\text{?} \text{?} = - \text{?} π \text{?} \text{?} \text{?}$$

$$\text{?} \text{indicates text missing or illegible when filed}$$

By assuming room temperature values for the viscosity of air and considering a singularly charged aerosol particle:

$$U = 2.2 \times \text{?} \text{?}$$

$$\text{?} \text{indicates text missing or illegible when filed}$$

The breakdown electric field for room temperature air is ˜3×10⁶ V/m so the greatest possible velocity due to a lens, Umax, is about 66 mm/s. As the residence time of the growing particles is approximately ten seconds and the radius of a growth furnace is about 100 mm, this velocity would clearly be sufficient to transport CNTs into the central zone of the furnace. However, the lenses can be considerably weaker at ambient pressure than in vacuum where stokes drag would be absent.

3. Fixed Catalyst Nanotube Alignment

CNT alignment, in some embodiments, can be implemented by the use of a fixed catalyst alignment system. In such an approach, the catalysts from which CNTs can grow may be fixed to a moving substrate (e.g. a belt) and the system may introduce a flow gas to cause, for example, orthogonal growth of CNTs and alignment. Such a system may allow for the formation of tubes having an extended length, ranging from about 1 mm to about 1, 10 or more cm.

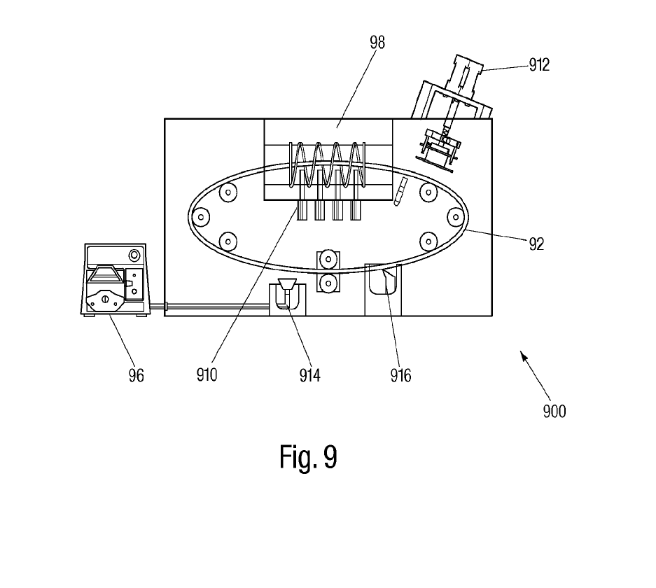

Looking now at FIG. 9, system 900 for fixed catalyst alignment is provided. System 900, in one embodiment, includes a moving substrate 92, such as a belt (as shown) or a series of belts, or multiple alumina tapes, spinning disks, or strings to which catalysts particles can be affixed or deposited. System 900, in an embodiment, can have within it one or more subsystems including means 914 for applying catalysts to belt 92. In one embodiment, means 914 can act to project catalysts particles at substantially right angles onto belt 92. In some embodiments, means 914 can also act to project a carbon source (e.g. fuel), such as ethylene, along with catalysts particles. System 900 can also include a collection system 912 to draw off the completed yarns formed from the CNTs growth on belt 92, and a scraping device 916 to remove the old or residual catalyst from the belt 92, so the system 900 can start the process once again. The growth rate of CNTs in system 900 can be enhanced by placing multiple belts or strings which can hold the catalysts. In the latter case, the substrates can be prepared in advance and be a consumable so that cleaning and applying the catalyst can be done as a separate operation.

In some embodiments, catalysts placed directly on a moving substrate 92 can include, but are not limited to, preformed iron particles, a catalyst precursor such as iron ammonium sulfate, iron pentacarbonyl, ferrocene, nickelocene, cobaltocene, and other metalorganic compounds, or oxide (zirconia) or metalloid which can form a metal or alloy upon thermal decomposition and combinations thereof. It may advantageous to have small amounts of copper, (for example, up to 10% by weight), added to the iron which inhibits graphitization of the carbon. Alternatively it is possible to add pure iron carbide or iron-copper-carbide catalysts as a preformed power to the spray where the particles can impinge directly on the moving, drum, belt, or thread. In some embodiments, the catalyst can be an alloy catalyst to control or prevent the Ostwald Ripening. The catalysts, depending on their type, can be calcined then reduced prior to introduction to the furnace chamber. The catalysts can be are then heated to a temperature depending on the fuel type and exposed to a cracked ethanol, ethylene or the like, to start the growth process in a direction of the gas flow.

Still referencing FIG. 9, as the substrate (e.g. belt 92) moves clockwise, the catalyst particles on belt 92 may be heated to a temperature ranging from about 700° C. to about 1,000° C., for example at about 850° C. by a heater in zone 98. Carbon source (i.e., fuel) may be sprayed into zone 98 through injectors 910 and in the presence of heat, CNTs may grow on and from the catalyst particles. The CNTs may then be directed horizontally away from zone 98 by belt 92 and collected by collection system 912. In some embodiments, the belt 92 is thin on its top surface to enable nanotubes to be uniformly pulled off by the collection or spinning system 912.

In one embodiment, collection system 912 may be designed with a pitch angle set, for example, to 15 degrees. For the purposes of measurement of CNT alignment, this pitch angle can be set to 0 degrees. In some embodiment, the collection system 912 can be controlled by a microcomputer (not shown). In some embodiments, system 900 can include a cleaning system 916, of the substrate, such as scraper, to allow new catalysts to be placed on the moving substrate.

### II. Ex Situ Nanotubes Alignment

1. Horizontal Anchor

In some aspect of the present invention, non-woven CNT sheets can be produced as a substantially planar, near anisotropic material by matching the velocity of the collection roller surface to the velocity of the CNT mass exiting the furnace. To subsequently elongate or stretch the collected CNT mass, two fixed rollers may be used whereby the velocity of the two rollers are mismatched. A simple way to create the required tension within the CNT mass is to intercept the mass with a rotating drum that matches the reaction tube exit velocity and then draw the mass off this drum at a higher velocity. This way, the CNT sock can undergo stretching between the anchor and the take up drum, the rotating anchor pulls the CNT sock out and help aligning the sock on the drum.

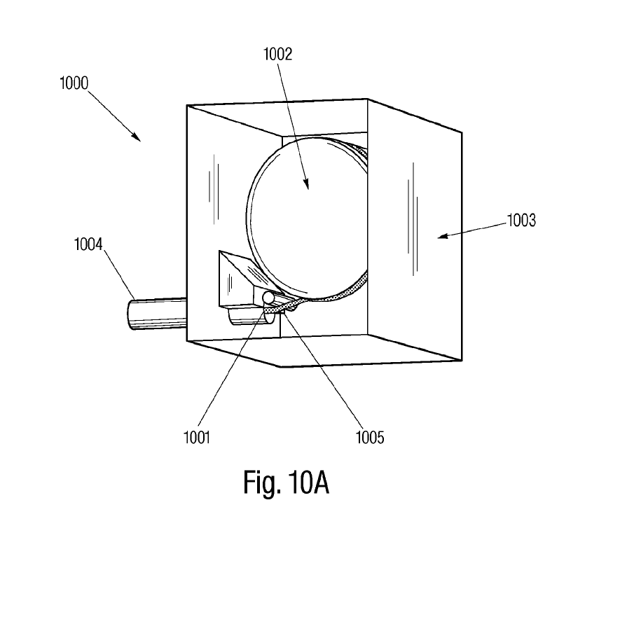

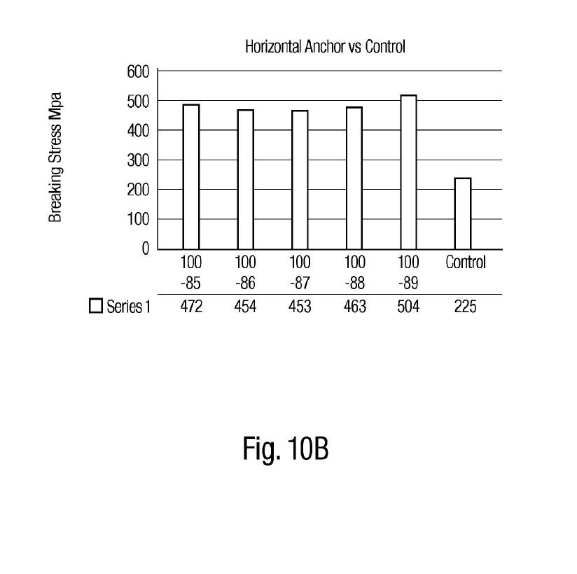

FIG. 10A is a schematic diagram of a horizontal anchor system 1000, showing the rotating horizontal anchor 1001 (i.e. drum), the collection drum 1002, the collection system enclosure 1003 (or housing) in fluid communication with the furnace tube 1004, the CNT material 1005 of the present invention elongated by speed mismatch between anchor 1001 and drum 1002. Still referring to FIG. 10A, a cylindrical horizontal anchor 1001, in an embodiment, may be positioned forward of the exit of the furnace tube 1004. This anchor 1001 can be outfitted with an externally controlled variable speed drive (not shown). The position of the anchor 1001 relative to the exit of furnace tube 1004 can be controllable from outside the furnace enclosure. For example, although illustrated as being above the collected CNT material 1005, anchor 1001 can be positioned below the collected CNT material 1005. In one embodiment, temperature control for the anchor 1001 can be controlled by the take-up and release characteristics of the anchor 1001. FIG. 10B shows the strength increase of the CNT material harvested by the horizontal anchor system.

2. Chemical Post Processing Alignment

According to some aspects of the invention, the nanofibrous material (e.g. yarn, or sheet) can be wetted and/or chemically treated and stretched using a process and system similar to that described in co-pending U.S. application Ser. No. 12/170,092. In some embodiments the CNT material of the present invention can be subsequently subjected sonication-aided post-processing stretching with Dioxolane (DOX) to improve strength, stretching with chlorosulfonic acid to improve strength and electrical conductivity. In some embodiments, post processing pyrolysis, such as Polyacrylonitrile (PAN) pyrolysis, can improve various characteristics of the CNT material of the present invention, such as strength and modulus.

### Applications

Sheets, yarns, and fibers of carbon nanotubes made from the present invention can have a wide variety of applications, including as an electrical conductor. CNT material produced in accordance with various embodiments of the present invention can be used as a wire, an electromagnetic shield, a power delivery cable, etc. In an embodiment, a CNT sheet of the present invention, for example, can be rolled to form the conductor or shield of a coaxial cable. Additionally, CNT sheets can be layered in order to increase the conductive mass of the sheet to allow the sheet to carry more current. Similarly, CNT yarns can be used to form cable elements, such as conductive elements of coaxial cables, twisted pair cables, etc. The CNT yarns can be twisted or bundled into a larger yarn to increase the amount of conductive mass in the yarn and allow the yarn to carry more current. CNT material of the present invention can also be used to make electrical connections on circuit boards, such as printed circuit boards (PCB), etc.

Examples of specific applications of the CNT material of the present invention can also include electromagnetic interference shielding (EMI shielding) which may reflect or absorb EMI radiation and thereby provide electrical shielding. Shielding may be beneficial to prevent interference from surrounding equipment and may be found in stereo systems, telephones, mobile phones, televisions, medical devices, computers, and many other appliances. Shielding may also be beneficial to reduce electromagnetic emissions that radiate from electronic devices. Reducing such radiated emissions can help the electronic device meet regulatory EMC requirements. The conductive layer may also be used as a ground plane or power plane, and may provide a means of creating an electromagnetic mirror.

While the present invention has been described with reference to certain embodiments thereof, it should be understood by those skilled in the art that various changes may be made and equivalents may be substituted without departing from the true spirit and scope of the invention. In addition, many modifications may be made to adapt to a particular situation, indication, material and composition of matter, process step or steps, without departing from the spirit and scope of the present invention. All such modifications are intended to be within the scope of the claims appended hereto.

1. A system for producing aligned nanotubes, the system comprising:
a synthesis chamber having a pathway into which a mixture can be introduced to generate nanotubes;
a hot zone within the chamber and along which a volume of nanotubes can be generated from the mixture; and
an alignment region along the synthesis chamber downstream of the hot zone through which the volume of nanotubes can be condensed and the nanotubes deflected into substantial alignment relative to one another.

2. A system as set forth in claim 1, wherein the alignment region is a tapered section of the synthesis chamber with a relatively smaller diameter pathway therethrough to condense and deflect the nanotubes into substantial alignment.

3. A system as set forth in claim 2, further having, downstream of the tapered section, a conical section with a relatively constricted diameter relative to the tapered section to further condense and align the nanotubes.

4. A system as set forth in claim 1, wherein the alignment region is a conical section of the synthesis chamber with a relatively smaller diameter pathway therethrough to condense and deflect the nanotubes into substantial alignment.

5. A system as set forth in claim 1, further having perforations positioned substantially circumferentially about the alignment region through which a flow of gas can be introduced in order to minimize adherence for the nanotubes to the alignment region.

6. A system as set forth in claim 1, wherein the alignment region includes a disc having at least one orifice through which the volume of nanotubes can flow, the orifice having a diameter relatively smaller than that of the pathway to condense and deflect the nanotubes into substantial alignment.

7. A system as set forth in claim 6, wherein the disc is at an angle to the volume of nanotubes so as to minimize build up of the nanotubes at the orifice of the disc.

8. A system as set forth in claim 1, wherein the alignment region includes a plurality of discs in linear alignment relatively to one another, each successive downstream disc having a successively smaller diameter orifice to further condense and align the nanotubes.

9. A system as set forth in claim 1, wherein the alignment region includes an electrostatic lens that can generate an electrostatic field to condense and deflect the volume of nanotubes into substantial alignment moving therethrough.

10. A system as set forth in claim 1, wherein the alignment region includes a plurality of electrostatic lenses in co-axial alignment with one another and having different voltages so as to successively condense and align the nanotubes moving therethrough.

11. A system as set forth in claim 10, further having a particle charger upstream of the alignment region to charge the mixture from which nanotubes can be generated.

12. A system as set forth in claim 1, wherein the volume of nanotubes is free-flowing.

13. A system as set forth in claim 1, wherein the pathway includes a rotating looped belt onto which the mixture can be affixed.

14. A system as set forth in claim 13, wherein the belt can be rotated into the hot zone to permit growth of nanotubes from the affixed mixture on the belt.

15. A system as set forth in claim 13, wherein the hot zone can include an injector for introducing an additional carbon source to the mixture for nanotube growth.

16. A system as set forth in claim 13, further including a scraping device downstream of the hot zone to remove residue of the mixture once the nanotubes have been collected.

17. A system as set forth in claim 1, further having a rotating anchor positioned adjacent an exit of the synthesis chamber and around which the nanotubes exiting the synthesis chamber can be directed for subsequent stretching and further alignment.

18. A system as set forth in claim 17, wherein the anchor includes a series of slots provided circumferentially about the anchor and to which the nanotubes can be restrained while being pulled by a downstream force to further align the nanotubes.

19. A system as set forth in claim 1, wherein the mixture comprises catalyst particles, a carbon source and a carrier gas.

20. A system for alignment of nanotubes collected from a furnace, the system comprising:
a housing in fluid communication with the furnace;
a first drum rotatable at a predetermined velocity, and being positioned within the housing adjacent an exit of the furnace to permit a collection nanotubes from the furnace to be deposited thereon; and
a second rotatable drum being positioned downstream of the first anchor to receive nanotubes directed from the first anchor, the second drum rotatable at a velocity different from that of the first drum in order to stretch and align the collection of nanotubes.

21. A system as set forth in claim 20, wherein the velocity of the second drum is higher than that of the first drum.

22. A method for producing aligned nanotubes, the method comprising:
producing a volume of nanotubes within a pathway;
directing the volume of nanotubes downstream along the pathway through a constrained region; and
deflecting the nanotubes moving through the constrained region into substantial alignment relative to one another.

23. A method as set forth in claim 22, wherein, in the step of directing, the constrained region includes one of a tapered section of the pathway, a conical section of the pathway, or both.

24. A method as set forth in claim 22, further includes directing a flow of gas circumferentially about the volume of nanotubes in the constrained region to minimize adherence of the nanotubes to the pathway.

25. A method as set forth in claim 22, wherein, in the step of directing, the constrained region includes one or more discs, each having at least one orifice with a diameter smaller than that of the pathway, and through which the volume of nanotubes can flow.

26. A method as set forth in claim 25, wherein, in the step of directing, each successive disc includes a successively smaller orifice to further constrain the volume and align the nanotubes.

27. A method as set forth in claim 22, wherein, in the step of directing, the constrained region includes one or more electrostatic lenses that can generate an electrostatic field.

28. A method as set forth in claim 27, wherein, in the step of directing, each successive electrostatic lens has a different voltage from the adjacent lens to further constrain the volume and align the nanotubes.

29. A method as set forth in claim 22, wherein the step of directing includes accelerating the volume of nanotubes through the constrained region to counteract randomization of the nanotubes within the volume.

30. A method as set forth in claim 22, wherein, in the step of directing, the volume of nanotubes is free-flowing.

31. A method as set forth in claim 22, wherein the step of directing includes rotating on a substrate the volume nanotubes affixed thereto.

32. A method as set forth in claim 22, further including collecting the aligned nanotubes from the pathway about a rotating anchor for subsequent stretching and further alignment.
